(19) United States
(12) Patent Application Publication
(10) Pub. No.: US 2021/0306561 A1
(43) Pub. Date: Sep. 30, 2021

(54) UNWANTED OBJECT OBSCUREMENT IN VIDEO STREAM

(71) Applicant: Lenovo (Singapore) Pte. Ltd., Singapore (SG)

(72) Inventors: Russell Speight VanBlon, Raleigh, NC (US); Mark Patrick Delaney, Raleigh, NC (US); John Carl Mese, Raleigh, NC (US); Arnold S. Weksler, Raleigh, NC (US); Nathan J. Peterson, Oxford, NC (US)

(21) Appl. No.: 16/833,226

(22) Filed: Mar. 27, 2020

(51) Int. Cl. H04N 5/232; H04N 5/262

(52) U.S. Cl. CPC H04N 5/23229; H04N 5/23218; G06K 9/6201; H04N 5/2621; H04N 5/2628

(57) ABSTRACT

One embodiment provides a method, including: capturing, using a camera of an information handling device, a video of a scene; transmitting the video to at least one other device via a video stream; determining, using a processor, whether at least one unwanted object is detected in the video of the scene; and performing, responsive to determining that the at least one unwanted object is detected in the video of the scene, an action that obscures visualization of the at least one unwanted object in the video stream. Other aspects are described and claimed.

### BACKGROUND

Users frequently communicate with each other through the use of information handling devices (“devices”), for example, smart phones, tablets, laptop and/or personal computers, and the like. Over the past two decades, video communication has become an increasingly popular communication means. More particularly, communications between users through a video feed are often used to facilitate social discussions between friends and family, to conduct business meetings between clients and service providers, to conduct and broadcast interviews, and the like.

### BRIEF SUMMARY

In summary, one aspect provides a method, comprising: capturing, using a camera of an information handling device, a video of a scene; transmitting the video to at least one other device via a video stream; determining, using a processor, whether at least one unwanted object is detected in the video of the scene; and performing, responsive to determining that the at least one unwanted object is detected in the video of the scene, an action that obscures visualization of the at least one unwanted object in the video stream.

Another aspect provides an information handling device, comprising: at least one sensor; a processor; a memory device that stores instructions executable by the processor to: capture a video of a scene; transmit the video to at least one other device via a video stream; determine whether at least one unwanted object is detected in the video of the scene; and perform, responsive to determining that the at least one unwanted object is detected in the video of the scene, an action that obscures visualization of the at least one unwanted object in the video stream.

A further aspect provides a product, comprising: a storage device that stores code, the code being executable by a processor and comprising: code that captures a video of a scene; code that transmits the video to at least one other device via a video stream; code that determines whether at least one unwanted object is detected in the video of the scene; and code that performs, responsive to determining that the at least one unwanted object is detected in the video of the scene, an action that obscures visualization of the at least one unwanted object in the video stream.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of obscuring visualization of an unwanted object in a video stream.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Situations may arise during a video communication stream where an unwanted object (e.g., another person, a pet, a sensitive or high priority object, etc.) may enter the field of view of a camera of one of the communicants. For example, an individual may be conducting a video-based business call with a client when the individual's child enters a room the individual is in. The child's presence and actions, if captured by the camera used to conduct the video call, may be distracting to the client. In another example, a man conducting a video-based call with his wife may be unaware that his wife's surprise birthday gift is situated in the background behind him. If the wife notices the object in the video stream the surprise may be ruined.

Certain solutions exist for audio-based communications that are able to reduce the impact of disruptive audio (e.g., microphone noise cancelling, etc.). However, there is no similar automatic disruption reducing feature for video communications. Rather, to limit the effect of these distracting visuals on the video stream a user currently may try their best to manually obscure the unwanted object (e.g., by shifting their body or other objects to try and block the unwanted object from the camera's field of view, etc.). This solution is burdensome to implement and may cause additional visual distractions that arise from the user's attempts to obscure the unwanted object. Alternatively, in another solution, a user may rush to pause or end the video after noticing that an unwanted object is present. This solution is also not optimal because it requires the video stream to be interrupted in some way. Additionally, the user may not be able to stop the video before a participant in the video stream notices the unwanted object.

Accordingly, an embodiment provides a method for dynamically negating a visual disturbance caused by an unwanted object detected in a field of view of a camera during a video stream. In an embodiment, a video of a scene may be captured and transmitted to at least one other device via a video stream. An embodiment may then determine whether at least one unwanted object is detected in the video of the scene (e.g., via one or more object detection and video analysis techniques, etc.). Responsive to determining that at least one unwanted objected is detected in the video, an embodiment may perform an action that obscures visualization of the unwanted object(s) (e.g., an embodiment may: automatically pause the video stream until the unwanted object is no longer detected, zoom in on another object or portion of the scene, digitally obscure or filter out the unwanted object from the video stream, implement a background change in a portion of the video that contains the unwanted object, etc.). Such a method may more efficiently and seamlessly reduce disruptions caused by unwanted objects in video streams.

The illustrated example embodiments will be best understood by reference to the figures. The following description is intended only by way of example, and simply illustrates certain example embodiments.

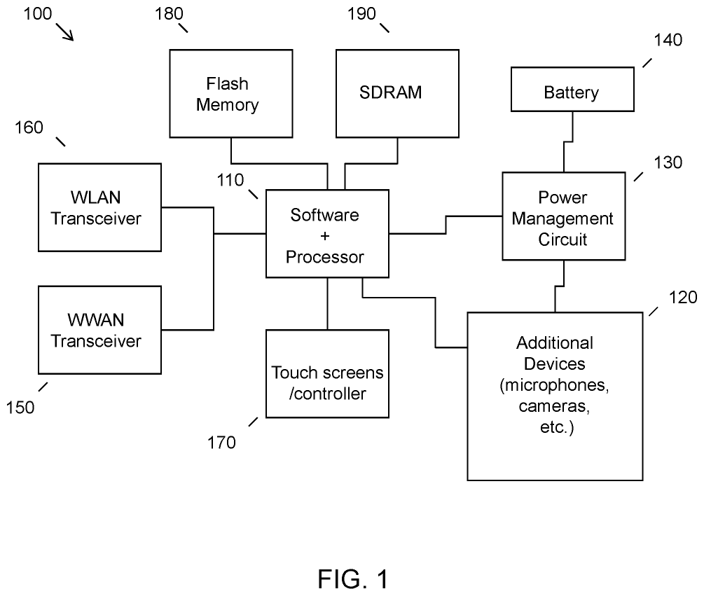

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

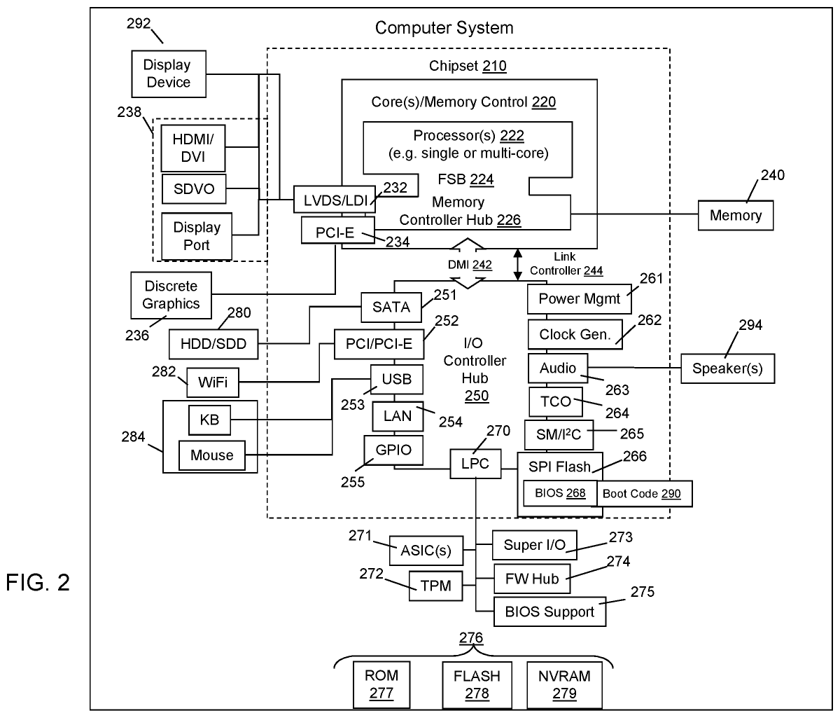

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices that may be capable of video and transmitting that video to one or more other devices. For example, the circuitry outlined in FIG. 1 may be implemented in a smart phone or tablet embodiment, whereas the circuitry outlined in FIG. 2 may be implemented in a laptop.

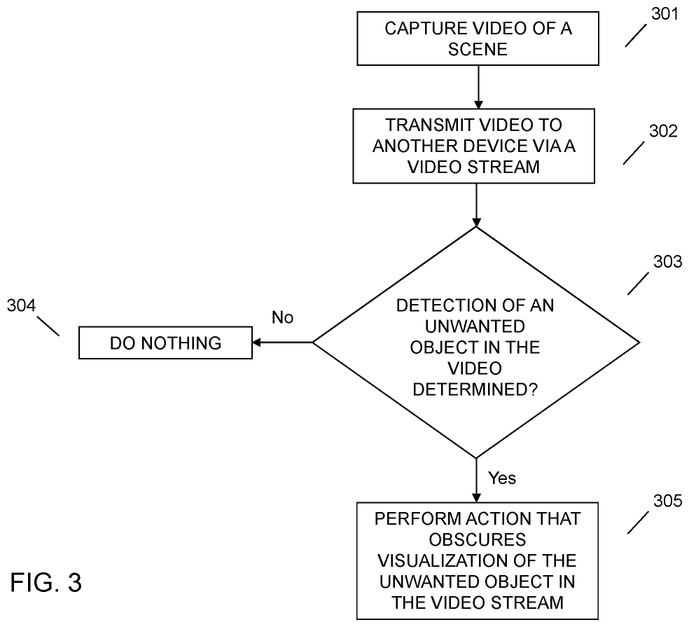

Referring now to FIG. 3, an embodiment provides a method for dynamically negating visual disruptions caused by unwanted objects entering a video feed. At 301, an embodiment may capture a video of a scene. In an embodiment, the video may be captured by a camera integrally or operatively coupled to a device. In an embodiment, the camera may be configured to always record video or, alternatively, may be configured to only initiate video recording responsive to receiving a certain indication to do so (e.g., upon initialization of a particular application, upon initiation of a video feed in an application, upon activation of a “record” button by a user, etc.).

At 302, an embodiment may transmit the video to at least one other device via a video stream. In an embodiment, the video stream may be supported by a video streaming application and may facilitate video communications between the user's device and another device associated with at least one other individual. In an embodiment, the nature, or formality, of the video stream may be dynamically determined. For example, an embodiment may determine whether the video stream is for social purposes, for business purposes, etc. An embodiment may do this via one or more different means. For example, an embodiment may determine the identity of the participants (e.g., from available context data, etc.) and from this information may conclude whether the user is engaging in a call with friends or clients. In another example, an embodiment may identify a location where the user is engaging in the video stream. For example, if the video stream is being produced in the user's office at work, an embodiment may conclude that the video-based communication is a work-based call. This determination may affect the actions that may be performed, as further described below.

At 303, an embodiment may determine whether at least one unwanted object is detected in the video of the scene. An unwanted object may refer to a person, an animal (e.g., a pet, etc.), a sensitive object (e.g., a secret company product, a surprise birthday gift, etc.), and the like. An original listing of the types of unwanted objects detectable by the embodiments may be set by a manufacturer. This list may later be adjusted by a user, i.e., the user may include additional object types that they want considered as unwanted objects. In an embodiment, detection of unwanted objects may be facilitated by first analyzing the video content captured by the camera (e.g., using one or more video analysis techniques known in the art, etc.) and then comparing one or more objects detected in the analysis to an accessible database of unwanted object types to determine if there is a match. In an embodiment, the determination and detection process may be performed either continuously, at predetermined intervals (e.g., every 5 seconds, 10 seconds, etc.), responsive to a predetermined event (e.g., upon initiation of a video stream, etc.), etc.

Responsive to determining that an unwanted object was not detected in the video, at 303, an embodiment may, at 304, take no additional action. Conversely, responsive to determining that an unwanted object was detected in the video, at 303, an embodiment may, at 305, perform an action that obscures visualization of the unwanted object in the video stream. The performance of the action may be conducted automatically and without any additional user input.

In an embodiment, the action may correspond to a video stream pausing action. For example, an embodiment may temporarily pause the video stream upon detection of an unwanted object. In an embodiment, the stream may be paused for a predetermined period of time (e.g., 5 seconds, 10 seconds, etc.). This may allow a user to address the visual disruption prior to stream restart. Alternatively, in another embodiment, the stream may be paused until an embodiment has determined that the unwanted object is no longer detected by the camera. To provide some context for the pause, an embodiment may provide a notification to the other participants in the stream. For example, the notification may explain that the video stream is temporarily paused and will resume shortly or after a predetermined amount of time. In another example, the notification may provide a more detailed explanation of why the pause is occurring (e.g., an embodiment may inform the participants that the pause is being enacted so a visual disruption may be negated, etc.).

In an embodiment, the action may correspond to a zooming action. More particularly, an embodiment may identify a location in the video where the unwanted object is positioned and may thereafter dynamically exclude visualization of the unwanted object by zooming in on another object or location in the camera's field of view. For example, if a user is participating in a conference call and an unwanted object appears at a peripheral edge of the video, an embodiment may zoom in on the user's face to prevent the unwanted object from appearing in the video. An embodiment may continue the zooming function until the unwanted object is no longer detected in the video. If the unwanted object adjusts its position and moves within a frame of the zoomed in video an embodiment may further zoom, or readjust the focus position, to exclude capture of the unwanted object. Additionally or alternatively, control settings may exist that dictate where and/or on what objects an embodiment may zoom in on (e.g., settings may provide an indication to a camera to always zoom in on a user's face when an unwanted object is detected, etc.).

In an embodiment, the action may correspond to a digital obscuring action. More particularly, an embodiment may identify a location in the video where the unwanted object is positioned and may thereafter place a digital graphic overtop of the unwanted object to obscure it from view. The digital graphic may be virtually any graphic accessible by and available to the system (e.g., an image, an animation, a mosaic blur effect, etc.). In an embodiment, a user may select the exact graphic that is used in each situation or, alternatively, the selection may be dynamically facilitated by the system. Regarding the latter, a system may dynamically select a graphic that draws the least visual attention to the unwanted object. For example, an embodiment may choose a graphic that blends in with the surrounding colors and/or objects around the unwanted object. In an embodiment, if the unwanted object moves around the video frame then the digital graphic may correspondingly move around with it.

In an embodiment, a background change may be implemented to obscure the unwanted object from view. More particularly, an embodiment may utilize one or more object detection techniques to identify certain aspects of a user (e.g., the user's face, the user's body, etc.) and then temporarily superimpose those aspects into a different scene. For example, an embodiment may place the user's face into a blank background while the unwanted object is detected. The selection of the background that the user's face and/or body are superimposed into may be dictated by user preference or may be selected dynamically by the system. Regarding the latter, a system may intelligently select an appropriate background based upon the type of video-based communication a user is engaged in. For example, for a formal video-based communication (e.g., a business related call, etc.) an embodiment may select a more bland background whereas for a less formal call (e.g., a social call with friends, etc.) an embodiment may select a more exotic background.

In an embodiment, users may configure system settings to control how and/or which of the foregoing actions are to be implemented in different contextual situations. For example, if a user is engaged in a video-based business meeting the tolerance for unwanted objects may be very low (e.g., an embodiment may perform a visual disruption negation action each time an unwanted object is captured by the camera, etc.). Conversely, in another example, if a user is engaged in a video-based social call with a friend then the tolerance for unwanted objects may be higher (e.g., an embodiment may only perform a visual disruption negation action when the unwanted object is drastically affecting the quality of the video feed, etc.). In yet another example, users may control how the system reacts to different unwanted objects. For instance, the user may indicate that it is okay if certain co-workers appear in the background of the video but may demand the system to pause if children are detected. Additionally, users may be presented with the option of overriding a particular action. For example, if an embodiment pauses a video stream to prevent disruption by an unwanted object, a user may be able toggle out of the pause and resume stream function.

The various embodiments described herein thus represent a technical improvement to conventional methods of obscuring visualization of an unwanted object in a video stream. In an embodiment, a video of a scene may be captured by a camera of a device, which may thereafter be transmitted to at least one other device through a video stream. An embodiment may then determine whether at least one unwanted object is detected within the video and, responsive to arriving at a positive determination, an embodiment may perform an action to obscure visualization of the unwanted object from the stream. Such a method may negate the current need for a user to manually attempt to address a disruption.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
capturing, using a camera of an information handling device, a video of a scene;
transmitting the video to at least one other device via a video stream;
determining, using a processor, whether at least one unwanted object is detected in the video of the scene; and
performing, responsive to determining that the at least one unwanted object is detected in the video of the scene, an action that obscures visualization of the at least one unwanted object in the video stream;
wherein the performing the action comprises digitally obscuring the at least one unwanted object in the video stream, wherein the digitally obscuring comprises:
identifying a color associated with a surrounding of the at least one unwanted object; and
providing a digital graphic over the at least one unwanted object, wherein the digital graphic is composed substantially of the color associated with the surrounding.

2. The method of claim 1, wherein the at least one unwanted object is selected from the group consisting of a person, an animal, a sensitive object, and a high priority object.

3. The method of claim 1, wherein the determining whether the at least one unwanted object is detected comprises:
identifying at least one object in the video;
comparing the at least one object against a list comprising a plurality of unwanted objects; and
determining, based on the comparing, whether a match exists between the at least one object and one of the plurality of unwanted objects in the list.

4. The method of claim 1, wherein the performing comprises automatically performing without additional user input.

5. The method of claim 1, wherein the performing the action comprises pausing the video stream.

6. The method of claim 5, further comprising providing a notification to a user of the at least one other device that explains the pausing.

7. The method of claim 1, wherein the performing the action comprises zooming in on another object to exclude the at least one unwanted object from the video.

8. (canceled)

9. The method of claim 1, wherein the performing the action comprises implementing a background change in a portion of the video at least corresponding to a position of the at least one unwanted object.

10. The method of claim 1, wherein the performing the action comprises:
identifying a contextual nature of the video stream; and
adjusting the action based upon the identified contextual nature.

11. An information handling device, comprising:
at least one sensor;
a processor;
a memory device that stores instructions executable by the processor to:
capture a video of a scene;
transmit the video to at least one other device via a video stream;
determine whether at least one unwanted object is detected in the video of the scene; and
perform, responsive to determining that the at least one unwanted object is detected in the video of the scene, an action that obscures visualization of the at least one unwanted object in the video stream;
wherein the instructions executable by the processor to perform the action comprise instructions executable by the processor to digitally obscure the at least one unwanted object in the video stream, wherein the digitally obscuring comprises:
identifying a color associated with a surrounding of the at least one unwanted object; and
providing a digital graphic over the at least one unwanted object, wherein the digital graphic is composed substantially of the color associated with the surrounding.

12. The information handling device of claim 11, wherein the at least one unwanted object is selected from the group consisting of a person, an animal, a sensitive object, and a high priority object.

13. The information handling device of claim 11, wherein the instructions executable by the processor to determine comprise instructions executable by the processor to:
identify at least one object in the video;
compare the at least one object against a list comprising a plurality of unwanted objects; and
determine, based on the comparing, whether a match exists between the at least one object and one of the plurality of unwanted objects in the list.

14. The information handling device of claim 11, wherein the instructions executable by the processor to perform the action comprise instructions executable by the processor to pause the video stream.

15. The information handling device of claim 14, wherein the instructions are further executable by the processor to provide a notification to a user of the at least one other device that explains the pausing.

16. The information handling device of claim 11, wherein the instructions executable by the processor to perform the action comprise instructions executable by the processor to zoom in on another object to exclude the at least one unwanted object from the video.

17. (canceled)

18. The information handling device of claim 11, wherein the instructions executable by the processor to perform the action comprise instructions executable by the processor to implement a background change in a portion of the video at least corresponding to a position of the at least one unwanted object.

19. The information handling device of claim 11, wherein the instructions executable by the processor to perform the action comprise instructions executable by the processor to:
identify a contextual nature of the video stream; and
adjust the action based upon the identified contextual nature.

20. A product, comprising:
a storage device that stores code, the code being executable by a processor and comprising:
code that captures a video of a scene;
code that transmits the video to at least one other device via a video stream;
code that determines whether at least one unwanted object is detected in the video of the scene; and
code that performs, responsive to determining that the at least one unwanted object is detected in the video of the scene, an action that obscures visualization of the at least one unwanted object in the video stream
wherein the code that performs the action comprises code that digitally obscures the at least one unwanted object in the video stream, wherein the code that digitally obscures comprises:
code that identifies a color associated with a surrounding of the at least one unwanted object; and
code that provides a digital graphic over the at least one unwanted object, wherein the digital graphic is composed substantially of the color associated with the surrounding.
